(19) United States
(12) Patent Application Publication
(10) Pub. No.: US 2011/0231168 A1
(43) Pub. Date: Sep. 22, 2011

(54) METHOD FOR PRODUCING A FLEXIBLE MECHATRONIC SYSTEM

(75) Inventors: Mathieu Grossard, Montrouge (FR); Christine Rotinat-Libersa, Le Plessis Robinson (FR); Nicolas Chaillet, Bonnay (FR)

(73) Assignees: Commissariat A L'Energie Atomique Et Aux Energies Alternatives, Paris (FR); Centre National De La Recherche Scientifique, Paris (FR)

(21) Appl. No.: 13/055,468

(22) PCT Filed: Jul. 8, 2009
(86) PCT No.: PCT/EP2009/058696

§ 371 Date: May 21, 2011

(30) Foreign Application Priority Data
Jul. 25, 2008 (FR) 0804255

(51) Int. Cl. G06F 17/50

(52) U.S. Cl. 703/2

(57) ABSTRACT

A method for producing a flexible mechatronic system includes: a step of modeling the system by a mesh including a given combination of elementary blocks, each block being formed of a predefined assemblage of segments representing elementary beams, the mesh including at least one active block controllable by means of a control signal; a step of simulating the behavior of a terminal node of the model in open-loop response to a control signal; a step of characterizing said response by at least one static mechanical criterion and at least one numerical criterion representative of the decay of the resonance spikes of the response as a function of frequency. The above steps may be repeated. The method further includes a step of selecting a design as a function of the criteria defined in the characterization step, the system being produced on the basis of the selected model.

The present invention relates to a method for producing a flexible mechatronic system.

Mechatronics is a discipline which is at the crossroads between mechanics and automation. Numerous systems thus pertain to mechatronics. Such is the case for example for robotic systems. The dimensions involved may be in the field of miniaturization, typically the microrobotics field, or may be of the order of several meters as in the case of large poly-articulated robots.

If the case of microrobotics is considered by way of example, a designer must assess two problems at one and the same time, the problem of miniaturization and the problem of the control of these systems. The production of microrobots by miniaturization of traditional robots comes up against technological and physical barriers. The miniaturization efforts must be applied up front in several fields, notably in the design of transmission structures and actuators for the application of forces and displacements in volumes of the order of a cubic centimeter.

Other actuation and measurement means must be studied, so as to achieve the desired mechanical performance, controllability and observability. This scale effect, as well as the nature of the systems designed, both specific to microrobotics, render the analysis and the writing of the dynamic and kinematic models difficult. The motions are then difficult to predict. The dynamic behavior is highly non-linear and the control laws are consequently rendered complex.

There is therefore a need to solve this two-fold problem encountered when designing a system pertaining to mechatronics, that is to say to address both mechanical performance and also the control requirements. More generally, there is a need to address the problem of the global optimal design of mechatronic structures, notably flexible ones, from a two-fold point of view: mechanics and automation.

Indeed, the use of mechanical criteria alone, generally static but also sometimes dynamic, can lead to a set of solutions from among which many are not able to be controlled in practice.

In the case notably of flexible microrobotic structures, solutions are known. More often than not, flexible microrobotic structures are rendered active by piezoelectric actuation, an active structure being a structure which integrates its actuation. Indeed, piezoelectric actuators possess beneficial properties of force resolution and passband. On the other hand, their low deformation, of the order of 0.1%, does not permit significant strokes and may limit the performance of the system actuated in certain cases.

A great deal of work has dealt with the parametric optimization of piezoelectric actuators, this optimization being oriented from the point of view of static mechanics. The existing designs are based essentially on the designer's intuition and/or experience and the optimization scheme makes it possible only to adjust the values of the dimensional parameters of a predefined form. Most optimizations relate to improving the mechanical performance of a basic actuator, generally its play. A basic actuator may be notably a simple uni-morph or bi-morph beam or a multilayer actuator. Implemented schemes also exist which make it possible to optimize the shape of an amplifying passive structure of a basic piezoelectric actuator so as to optimize the play of the resulting assemblage, as is notably described in the article by M. Frecker and S. Canfield “Optimal design and experimental validation of compliant mechanical amplifiers for piezoceramic stack actuators”, Journal of Intelligent Material Systems and Structures, Vol. 11, pages 360-369, 2000. Another general approach for optimizing the design of piezo-actuated structures is to simultaneously or separately optimize the size of the actuator, but not its shape. The article by H. Maddisetty and M. Frecker “Dynamic topology optimization of compliant mechanisms and piezoceramic actuators” ASME Journal of Mechanical Design, Vol. 126, Iss., pages 975-983, 2004, describes a solution where the size of the actuator is optimized separately, but not its shape or its position. The article by M. Abdalla et al “Design of a piezoelectric actuator and compliant mechanism combination for maximum energy efficiency”, Smart Material and Structures, Vol. 14 pages 1421-1430, 2005, describes a solution where a dynamic loading is performed at given frequency and the size of the actuator is simultaneously optimized.

In contradistinction to these schemes where the piezoelectric elements are placed a priori on the structure, several other works deal with the optimal placement of actuators on a given structure, as is notably described in R. Barboni et al “Optimal placement of PZT actuators for the control of beam dynamics”, Smart Material and Structures, pages 110-120, 2000. Finally, a few studies consider the optimization of the shape of the piezoelectric actuator as shown for example by E. C. Nelli Silva and N. Kikuchi “Design of piezoelectric transducers using topology optimization”, Smart Material and Structures, Vol. 8, pages 350-365, USA 1999.

None of these optimizations actually takes into account the simultaneous optimization of the structure and of the actuator, and still less the complete optimization of the system, including of its boundary conditions.

Other known forms of optimization take into account only the mechanical aspect. By way of example, certain microrobots move using the so-called “stick-slip” technique, as described notably in S. Fablbusch et al “Flexible Microbotic System MINIMAN: Design, Actuation Principle and Control”, Proc. of the IEEE/ASME International Conference on Advanced Intelligent Mechatronics, pages 156-161, Atlanta, Ga. USA, 1999 and utilize the large passband of the piezoelectric actuators, which make it possible to obtain motions with large dynamics and use in very fast frequency regimes. Now, a large part of the existing work in optimization of flexible so-called “compliant” mechanisms were interested only in the case of quasi-static applications, which can reveal structures which are sub-optimal in terms of dynamic regime, or indeed which are inappropriate, giving rise for example to the appearance of phase shifts or passive dampings. The schemes which include the analysis and optimization of frequency responses of active structures are very often interested in maximizing, or minimizing in the application case of active damping, the amplification of play or forces at a chosen harmonic loading, the actuator being used at a chosen frequency, the steady-state performance being ignored, see the aforementioned article by H. Maddisetty and M. Frecker. Finally these schemes only very rarely envisage optimizing the input/output relations over a wider frequency band, notably for damping applications.

As regards the control of flexible systems, a first difficulty encountered is the prior identification of all the dominant modes. This, necessary, step allows the construction of an appropriate reduced model. Now, the latter must address a two-fold objective, on the one hand be of a reasonable order so as not to complicate a posteriori the synthesis of the regulator and on the other hand be as close as possible to the dynamic behavior of the real flexible system, which is generally highly resonant. A certain number of approaches for reducing models exist, including among them the technique based on equilibrated production. This technique is generally based on an order of reduction of the complete model which, in reality, is of quasi-infinite dimension. From this technique emerges the difficulty of choosing the order for the reduced model and consequently its precision in relation to the non-truncated model.

A second difficulty resides notably in the choice to be adopted regarding the strategy and the synthesis proper of the control law faced with such systems with highly oscillating behavior.

An aim of the invention is to alleviate the drawbacks of the aforementioned schemes, by making it possible, in the production of a flexible mechatronic system, to take into account very varied criteria so as to make it possible on the one hand to facilitate the calculation of the most precise reduced model possible, and on the other hand to facilitate the control of the vibratory behavior of this type of structure.

For this purpose, the subject of the invention is a method for producing a flexible mechatronic system, comprising at least:
a step of modeling the system by a finite element meshing;
a step of simulating the behavior of a terminal node (68) of the model in open-loop response to a control signal;
a step of characterizing said response by at least one mechanical criterion and at least one numerical criterion J₁^{k} representative of the relative amplitude of the resonance spikes of said response as a function of frequency, these resonance spikes being chosen respectively upstream and downstream of a predetermined mode number;
   the above steps being able to be repeated, these steps being followed by a step of selecting a design obtained as a function of the criteria defined in the characterization step, the system being produced on the basis of the selected design.

The criterion J₁^{k} is for example defined by the following relation:

$${J}_{1}^{k} = \frac{{\sum }_{i = 1}^{k} {σ}_{i}}{{\sum }_{i = k + 1}^{p} {σ}_{i}}$$

where k is the number of first modes having to be dominant with respect to all the other modes of said frequency response and defined on the basis of the state representation which completely characterizes the input/output relation of the mechanism, is the i-th Hankel Singular Value of the flexible system.

In a possible implementation of the method, the characterization step comprises another numerical criterion J₂^{k} representative of the alternation of the resonances and antiresonances of the response in the frequency domain, in a chosen frequency band.

The criterion J₂^{k} is for example defined by the following relation:

$${J}_{2}^{k} = \vert {\sum }_{i = 1}^{k} sign ( {c}_{i} {b}_{i} ) \vert$$

where k is the number of first resonance modes of said frequency response and cᵢ and bᵢ respectively represent the influence of the sensors and actuators on the input/output frequency response of the system.

An embodiment is for example selected when the criterion J₁^{k} is greater than a value chosen by the user/the designer.

An embodiment is for example selected when the criterion J₂^{k} is greater than a given value.

The mesh may be composed of a combination of elementary blocks to be determined, each permitted block being formed of a predefined assemblage of segments representing elementary beams, said mesh comprising at least one active block controllable by means of a control signal.

In another possible mode of implementation, the mesh being composed of a combination of elementary blocks to be determined, each permitted block being formed of a predefined assemblage of segments representing elementary beams, the mesh comprises at least one node controllable by means of a control signal.

The blocks arise for example from a library of predefined blocks.

A control of an active block can be exerted by a deformation signal for at least one of its beams.

A static mechanical criterion is for example the displacement δₓ of the terminal node.

The terminal node being an effector, a mechanical criterion is the value of the force that it applies to the exterior medium F_{X}, for example the clamping force.

Other mechanical criteria may be used, for example stresses, energies of deformation or spurious displacements.

The control signal is for example an electrical voltage or current signal.

The system is for example a piezoelectric actuator, all the beams constituting an active block being controlled by an electrical voltage signal.

Other characteristics and advantages of the invention will become apparent with the aid of the description which follows, offered in relation to appended drawings which represent:

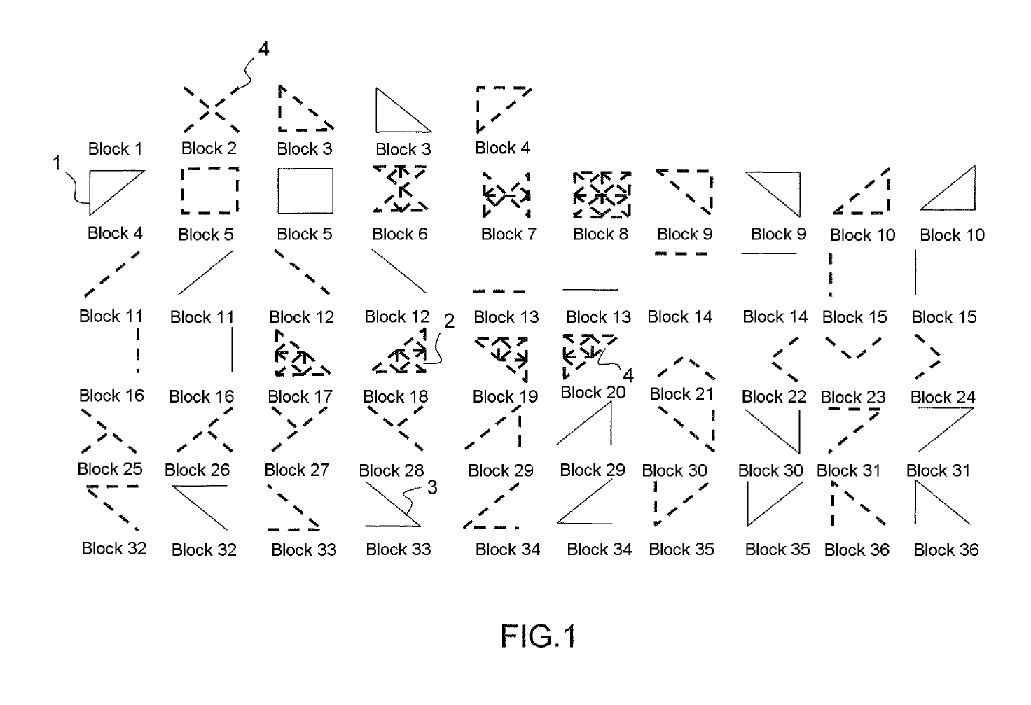

FIG. 1, an exemplary library of elementary flexible blocks used for a reduced modeling of a flexible mechatronic system;

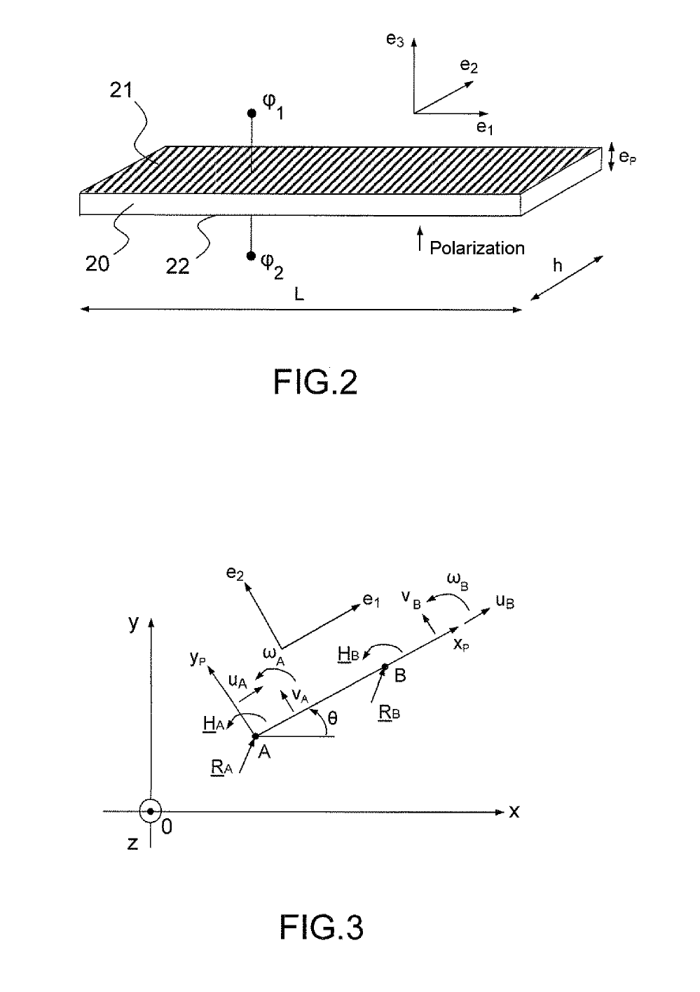

FIG. 2, an illustration of a piezoelectric beam, a constituent elementary part of a piezoelectric system or actuator;

FIG. 3, a curvilinear representation of the above piezoelectric beam represented by a segment and its orientation in a system of axes;

FIG. 4, a desired shape, possibly being considered to be ideal, of frequency response of a flexible mechatronic system;

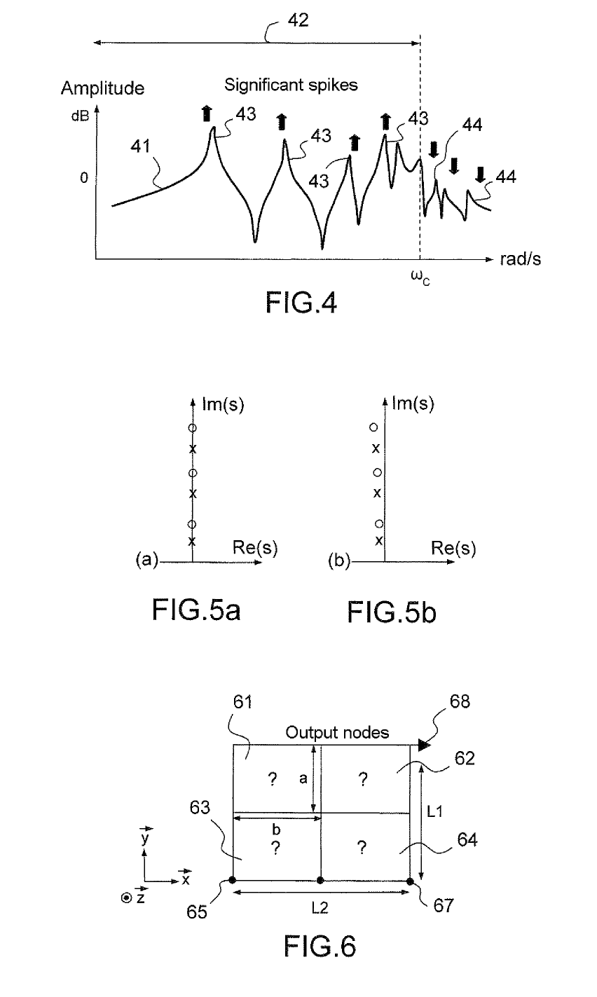

FIGS. 5a and 5b, the loci of the poles and zeros of the frequency response of a colocated system, respectively undamped and slightly damped;

FIG. 6, an exemplary mesh of a flexible mechatronic system whose constituent elementary blocks are to be defined, with a view to the design of the system;

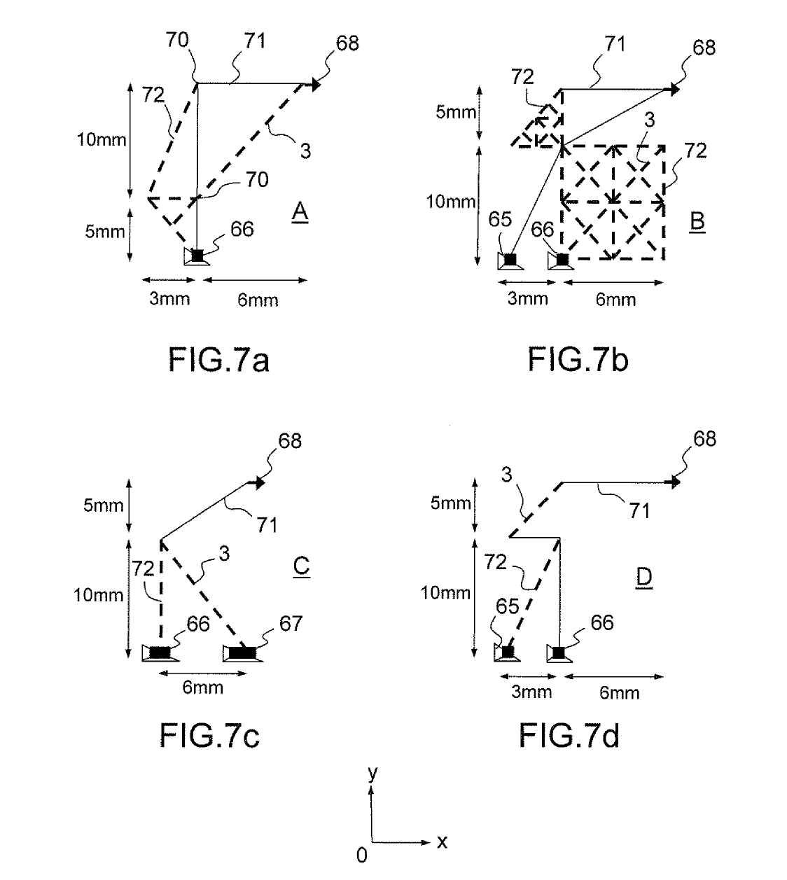

FIGS. 7a to 7d, examples of flexible system structures modeled by an assemblage of blocks based on the above mesh;

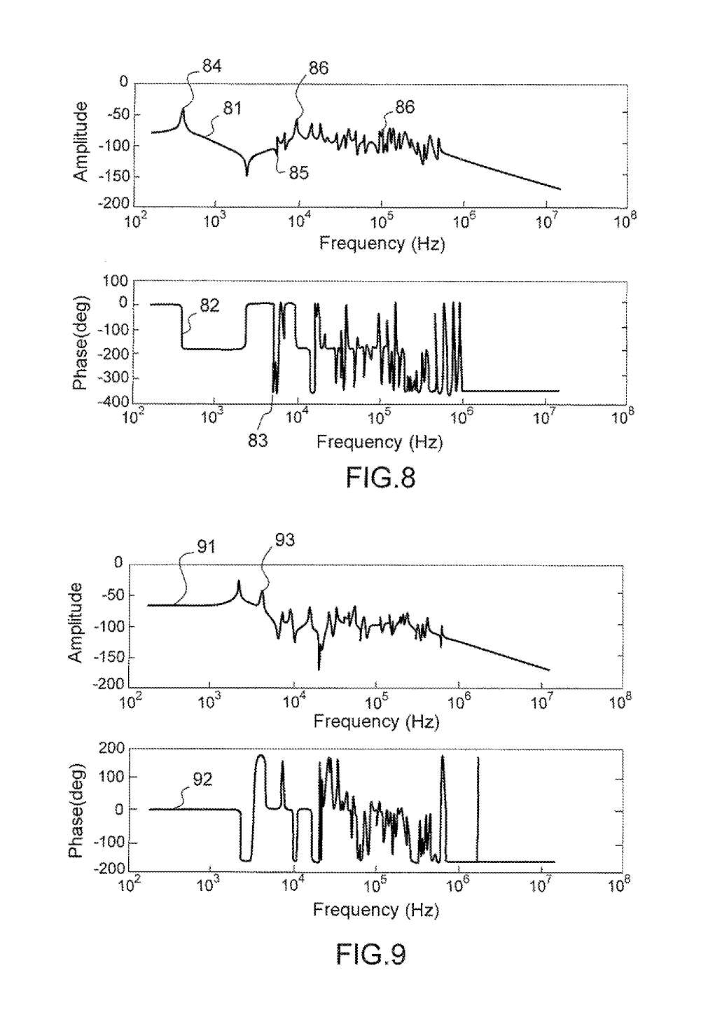

FIGS. 8 to 11, illustrations of the open-loop frequency response of each of the above structures.

FIG. 1 presents an exemplary library of active and passive elementary flexible blocks which is used in a scheme for designing flexible mechanisms. This more general scheme is notably described in the following documents:
Grossard M., Rotinat-Libersa C., Chaillet N., Perrot Y., “Flexible building blocks method for the optimal design of compliant mechanisms using piezoelectric material”, 12th IFToMM World Congress, Besancon, France, 2007;
Grossard M., Rotinat-Libersa C., Chaillet N., “Gramian-based optimal design of a dynamic stroke amplifier compliant micro-mechanism”, IEEE/RSJ International Conference on Robots and Systems, San Diego, USA, 2007;
Bernardoni P., et al., “A new compliant mechanism design methodology based on flexible building blocks”, Proceedings of Smart Structures—SPIE Modeling, Signal processing and Control Conference, San Diego, USA, Vol. 5383, pp. 244-254, USA, March 2004;
Rotinat-Libersa C., Perrot Y., Friconneau J.-P., “Potentialities of optimal design methods and associated numerical tools for the development of new micro- and nano-intelligent systems based on structural compliance—An example—”, IARP—IEEE/RAS-EURON Joint Workshop on Micro and Nano Robotics, Paris, France, 2006.

The library of FIG. 1 comprises for example 36 passive elements and 19 elements rendered active by piezoelectric effect 4. This library makes it possible to construct a large variety of topologies of structures. Each elementary block 1, 2, 4 consists moreover of a predefined assemblage of elementary beams, or segment 3.

The specification of the problem of the optimal design of flexible systems considers, within a given footprint, various boundary conditions: the points of linkage between the mechanism and the framework (position and list of the disabled degrees of freedom), the inputs (actuators), the outputs (effector nodes), the contacts. With regard to actuation, several principles may be envisaged:
either force or displacement actuators being able to act at particular nodes of the structure,
or active blocks arising from the corresponding library; these blocks can consist of piezoelectric material whose upper and lower surfaces are each covered with a conducting surface (called an electrode) and subjected to electrical potentials.

The interest in using active flexible blocks of varied topologies instead of simple piezoelectric beams is that this makes it possible to couple the degrees of freedom, so as to generate complex motions within a restricted footprint.

An aim of the design step therefore consists in seeking an optimal distribution of flexible blocks within a given footprint, as well as the optimal suite of parameters (optimization variables: materials, dimensions, boundary conditions, including actuators, etc.) which define flexible mechatronic structures, whose performance ratings (objectives to be optimized) are the closest to those specified in a given blueprint. Variables and optimization criteria are used.

As regards the optimization variables, several parameters may be used to define the structures. Some of these parameters may or may not be optimized, notably:
the points fixed to the framework (number, placement, degree of freedom concerned),
the topology of the structure (types of flexible blocks of the library, their nature—active and/or passive—, and their arrangement),
the material or materials constituting the passive blocks and their thickness
the thickness and the electrical potential difference between the upper electrode and the lower electrode (for the active blocks, which are at present piezoelectric material)
the unilateral contacts between the structure and the framework, or between two parts of the structure (number, degree of freedom concerned, play and placement),
the actuators (number, type of actuation, point of action, degree of freedom concerned and amplitude),
the sensors (number and placement only, at the present time).

The mechanical criteria available, for a static model, are notably:
Free displacement of the output degrees of freedoms (dofs)
Geometric advantage, i.e. amplification of the ratio of output displacement to input displacement
Force for disabling the output degrees of freedom
Mechanical advantage, i.e. amplification of the ratio of output force to input force
Inverse of the deformation energy
Inverse of the displacements orthogonal to the output displacement
Manipulability
Mass
Maximum mechanical stress
Critical buckling load.

Other mechanics-related criteria are available for a dynamic model. These use a formulation specific to the field of automation, based on the controllability grammian and observability grammian. These grammians are calculated on the basis of a state representation having as input an actuated or controlled node, and as output a single node as described notably in the aforementioned document “Gramian-based optimal design of a dynamic stroke amplifier compliant micro-mechanism”. For example, in this document, two criteria are:
shift the first resonance of the system beyond a chosen limit frequency. This criterion considers in an absolute manner all the first modes which have little influence on the input/output behavior of the system, without being concerned with the following modes. Furthermore, this method is aimed at minimizing the influence of the first modes only.
avoid the presence of resonances in an interval of frequencies chosen so as for example to filter undesirable motions transmitted from the base to the output.

One stochastic optimization scheme used is for example a genetic algorithm inspired by the code described in Deb K., et al., “A fast elitist non-dominated sorting genetic algorithm for multi-objective optimization: Nsga-II”, Proc. of the 6th Int. Conf. on Parallel Problem Solving from Nature, pp. 849-858, France, 2000. The optimal design scheme uses this optimization principle which allows a genuine multicriterion optimization (without a priori weighting of one criterion with respect to another), and the use of discrete variables. In this scheme, a discrete parameterization is designed, suited to the specification of flexible mechatronic structures. The structure of the algorithm is for example organized as follows:
In view of the blueprint of the system to be designed, the designer provides the admissible values of the parameters (which are the variables to be optimized);
The algorithm synthesizes individuals and then evaluates them according to the criteria chosen by the designer;
The stochastic operators, specific to genetic algorithms, modify the description of the structures by manipulations on their discrete variables, so as to synthesize new structures, which are thereafter evaluated as at the previous generation;
A new synthesis and evaluation cycle is performed, and so on and so forth, until convergence of the algorithm (achieving of the global optimum);
When convergence is achieved, the design algorithm provides a set of pseudo-optimal solutions, restored on one (or more in the case of more than 2 criteria) two-dimensional Pareto fronts.

Thereafter, the designer chooses and interprets the structures obtained which comply in an optimal manner with his blueprint.

The optimization process thus relies on a stochastic optimization technique (genetic algorithm) in which the candidate solutions are considered to be the individuals of a population. They are parameterized by chromosomes, themselves made of genes. The entire population evolves with simplified operators inspired by genetics, such as selection, mutation and crossing. For example, the genotype of an assemblage of flexible blocks is coded by a matrix of integers, each of the integers referring to the blocks of the active and passive libraries of FIG. 1. In an exemplary implementation employed, the active blocks are for example dominant over the passive blocks, which are themselves dominant over an empty block.

A modeling of the piezoelectric elementary flexible blocks 2 may be implemented. For this modeling, only the displacements and forces contained in the plane of the structure are considered.

The assumption is for example made that the flexible mechanisms are subjected to structural deformations, resulting mainly from the flexions of the beams constituting the blocks such as illustrated for example by FIG. 1. Thus, the model adopted for the blocks is obtained by considering the Navier-Bernoulli assumptions. The parameters defining the blocks are the thickness, the material, the width and the height (and the electrical potential difference between the upper and lower electrodes for the active blocks). The characteristics of the material of each block are parameterized by its Young's modulus, its Poisson's ratio, its elastic limit, its density (and the piezoelectric coupling coefficients for the active blocks). Before obtaining the formulation of the model of the piezoelectric blocks, a model of the simple beam is necessary first of all.

FIG. 2 illustrates a piezoelectric beam 20 with electrodes 21, 22 perfectly distributed over its upper and lower faces, polarized with potentials φ₁, φ₂ according to the thickness, and oriented in an orthotropic reference frame (e₁, e₂, e₃). Under the effect of the transverse piezoelectric coupling, a longitudinal deformation S₁₁ is caused along the dimension L by the electric field E₃ along the thickness. Considering the unidimensional form of the piezoelectric equations along the longitudinal axis of the beam, the matrices for the piezoelectric coupling d, electrical permittivity ε and compatibility s are each represented by a scalar coefficient, d₃₁, ε₃₃ and s₁₁ respectively. The constitutive relations of piezoelectricity for the deformation S₁₁ and the electrical displacement D₃ as a function of the stress T₁₁ and electric field E₃ are in this case reduced to:

$$\{ \begin{matrix}{S}_{11} \\ {D}_{3}\end{matrix} \} = [ \begin{matrix}{s}_{11} & {d}_{31} \\ {d}_{31} & {ɛ}_{33}\end{matrix} ] \{ \begin{matrix}{T}_{11} \\ {E}_{3}\end{matrix} \} \qquad ( 1 )$$

FIG. 3 illustrates a curvilinear representation of the piezoelectric beam 20, represented by a segment AB, and its orientation in a global reference frame system (0, x, y, z) with the reactions R_{A}, R_{B} and the nodal moments H_{A}, H_{B} at the ends of the beam.

The displacement field over a piezoelectric beam element is described by its longitudinal u, tangential v and rotational w components at the curvilinear abscissa xₚ (FIG. 3). It is expressed with respect to the corresponding nodal values of the beam, in the system of coordinates of the beam Rₚ=(A, xₚ, yₚ, zₚ):

η_{b}=(u_{A},u_{A},w_{A},u_{B},v_{B},w_{B})_{R}_{ₚ}^{t}

Hamilton's principle, generalized to electromechanical systems, provides the model of the dynamic behavior of the piezoelectric beam as described for example in A. Preumont “Mechatronics: Dynamics of Electromechanical and Piezoelectric Systems (Solid Mechanics and its Applications)”, published by Springer, Sep. 25, 2006:

M_{b}\ddot{η}_{b}+K_{b}η_{b}=G_{b}Φ_{b}+Fr_{b} (2)

The various matrices are calculated under the assumptions of a displacement field interpolated at the nodes of the beam, by the shape functions specific to Navier-Bernoulli beams:
M_{b} denotes the mass matrix;
K_{b} denotes the stiffness matrix;
G_{b} denotes the electromechanical coupling matrix, which induces the piezoelectric loading making it possible to produce the contraction or the elongation of the beam proportionately to the difference of potentials φ₁-φ₂;
φ_{b}=(φ₁,φ₂)^{t} is the vector of electrical potentials on the upper and lower faces of the piezoelectric beam;
Fr_{b}=(R_{A}^{x}R_{A}^{y}H_{A}^{z}R_{B}^{x}R_{B}^{y}H_{B}^{z})^{t} is the vector of mechanical nodal forces.

Just as for the passive blocks, the mass M_{B}, stiffness K_{B} and coupling G_{B} matrices of each active block are obtained by matrix assemblage of the mass M_{b}′, stiffness K_{b}′, and coupling G_{b}′ matrices of each constituent beam of the blocks. Each of the latter matrices is expressed in the global reference frame R′=(0, x, y, z) according to the formula for changing basis by:

M_{b}′=P^{t}M_{b}P

K_{b}′=P^{t}K_{b}P

G_{b}′=P^{t}G_{b}

where P is a conventionally obtained matrix for changing reference frame.

Before carrying out an optimization, the mass, electromechanical stiffness and coupling matrices of all the blocks of the library are numerically calculated, doing so by considering all the possible combinations of the various discrete values permitted by a designer for the optimization variables (materials, size of the blocks, etc.). This calculation is carried out just once. The results are kept in memory, thereby making it possible to save calculation time during the iteration processes for the optimization steps. During the optimization, the evaluation of the various criteria specified by the designer calls upon the calculation of the static or dynamic behavior model of the structures, depending on whether static, dynamic or automatic oriented mechanical criteria are considered.

In the dynamic and piezoelectric case (which is the most complete), the matrices (expressed in the reference frame R′) of all the constituent blocks of the structure are assembled to describe the conservative behavior of the mechanism according to:

M_{g}\ddot{η}_{g}+K_{g}η_{g}=G_{g}Φ_{g}+Fr_{g} (3)

This assemblage is carried out during the optimization process for each individual and at each generation. In relation (3), η_{g} refers to the nodal displacements of the trellis structure discretized into blocks, themselves discretized into beams. φ_{g} denotes the electrical potentials applied to the upper and lower electrodes of each block, and Fr_{g} the exterior mechanical forces applied to the system.

In the case of the dynamic calculation of a purely passive structure, equation (3) simplifies according to:

M_{g}\ddot{η}_{g}+K_{g}η_{g}=Fr_{g}

The actuator forces are considered this time as all external to the structure and included in the term Fr_{g}.

In the case of the calculation of the static behavior of a piezoelectric structure, the equation reduces to:

K_{g}η_{g}=G_{g}Φ_{g}+Fr_{g}

Finally, in the case of the calculation of the static behavior of a passive structure, the equation reduces to:

K_{g}η_{g}=Fr_{g}.

According to the invention, two numerical criteria J₁ and J₂ are used for the evaluation of the dynamic performance of the input-output transfer of flexible mechatronic systems. More particularly, these two criteria make it possible to define an optimization strategy with a view to the subsequent control of the flexible mechatronic systems to be produced. The criteria J₁ and J₂ pertain to the open-loop response of these structures. They allow notably the input-output frequency response to adhere to certain templates and certain constraints pertaining to the joint controllability and observability of certain vibration modes. The criterion J₁ pertains notably to the amplitude of the open-loop frequency response of a system and the criterion J₂ pertains notably to the phase of this frequency response. These two criteria J₁ and J₂ make it possible to characterize respectively the dynamic properties of a system model, in terms of amplitude and phase.

A first difficulty encountered during the control of flexible systems is the prior identification of the dominant modes. This, necessary, step allows the construction of an appropriate reduced model that must, ideally, address a two-fold objective, on the one hand be of a reasonable order so as not to complicate a posteriori the synthesis of the regulator and on the other hand be as close as possible to the dynamic behavior of the real flexible system, which is generally highly resonant.

A second difficulty resides notably in the choice to be adopted regarding the strategy and the synthesis proper of the control law faced with such systems with highly oscillating behavior. Faced with this two-fold problem, the two criteria J₁ and J₂ on the one hand make it possible to facilitate the calculation of the most precise reduced model possible and on the other hand to facilitate the control of the vibratory behavior of these structures.

Before formulating these criteria J₁ and J₂, modal equations for the motion of flexible structures are recalled.

In accordance with the document by K. B. Lim et al “Actuators and sensor placement for control of flexible structure”, in Control and Dynamics Systems: Advances in Theory and Applications, ed. London, Academic Press, 1993, each synthesized flexible structure is defined as a linear system of finite dimension, that can be controlled and observed, possessing slightly damped complex conjugate poles. Its conservative dynamic behavior is governed by the following 2^{nd} order differential matrix equations:

M_{g}\ddot{η}_{g}+K_{g}η_{g}=E_{g}u

y=F_{g}η_{g} (4)

Each element of u (respectively y) denotes an actuator (respectively sensor) whose degree of freedom is defined by a non-zero value in the corresponding column of E_{g} (respectively row of F_{g}).

Modal decomposition of the system makes it possible to seek a solution in the form:

$${η}_{g} = {\sum }_{i = 1}^{p} {Ψ}_{i} q = Ψ q$$

It consists of a linear combination of the modal deflections Ψᵢ. q is the vector of modal displacements of dimension p×1. The matrix of eigenvectors Ψ=[₁ . . . Ψₚ],

and the associated natural angular frequencies are obtained as
solutions of the following conservative problem:

(K_{g}−ωᵢ²M_{g})Ψᵢ=0.

It is assumed here that the damping has only little influence on the frequency positioning of the resonances of the flexible structures. The natural angular frequencies are arranged in ascending order ω₁²≦ . . . ≦ωₚ², and Ψ is chosen normalized with respect to the mass matrix M.

By replacing η_{g} by Ψ_{q} in relation (4) and multiplying on the left by Ψ^{t}, the orthogonality relations induced by the modal shape give:

\ddot{q}+diag(ωᵢ²)q=Ψ^{t}E_{g}u

y=F_{g}Ψg (5)

To obtain a state model of the structures, we choose for example the state vector x of dimension 2p×1 defined by:

x=(\dot{q}₁ω₁q₁ . . . \dot{q}ₚωₚqₚ)^{t}

The triple (A, B, C) of the state representation in the modal space

\dot{x}=Ax+Bu

y=Cx

takes the particular form

$${A}_{i} = [ \begin{matrix}- 2 {ξ}_{i} {ω}_{i} & - {ω}_{i} \\ {ω}_{i} & 0\end{matrix} ] , {B}_{i} = [ \begin{matrix}{Ψ}_{i}^{t} {E}_{g} \\ 0\end{matrix} ] , {C}_{i} = [ \begin{matrix}0 & \frac{1}{{ω}_{i}} {F}_{g} {Ψ}_{i}\end{matrix} ] \qquad ( 6 )$$

The evolution matrix A depends on the structure (natural frequencies and modal dampings), the control matrix B (respectively C) depends on the placement and nature of the actuators (respectively of the sensors). Hereinafter, Ψᵢ^{t}E_{g} (of dimension 1×s) will be denoted: bᵢ, and F_{g}Ψᵢ (of dimension r×1) will be denoted: cᵢ.

In the frequency domain, the transfer matrix between the inputs u and the outputs y is seen as the sum of all the modal contributions:

y(jω)=G(jω)u(jw)

where the r×s transfer matrix equals:

$$G ( jω ) = {\sum }_{i = 1}^{p} {G}_{i} ( jω ) = {\sum }_{i = 1}^{p} \frac{{c}_{i} {b}_{i}}{{ω}_{i}^{2} - {ω}^{2} + 2 j {ξ}_{i} {ω}_{i} ω} .$$

FIG. 4 presents a desired shape of the open-loop frequency response of a flexible system, for example of a structure consisting of a set of piezoelectric beams. This shape is represented by a curve representative of the amplitude, expressed in dB, with respect to the angular frequency, expressed in radians/seconds. To increase the authority of control over the various modes, the amplitudes of the resonances must be maximized in the frequency band [0, ω_{c}], or passband 42, such as illustrated by the significant spikes 43 of curve 41 inside this frequency band 42. Conversely, the amplitudes of the resonance spikes 44 after the cutoff angular frequency ω_{c} must be minimized so as to limit the margin of gain and to limit the so-called “spillover” phenomena.

The criterion J₁ defined subsequently makes it possible notably to evaluate whether the response of a system model approximates the ideal case of FIG. 4. Stated otherwise, the criterion J₁ makes it possible to evaluate the reduction capacity of the model and its precision. The interpretation that it is possible to take the norm H_{∞} of the transfer matrix makes it possible to write such a criterion for obtaining this shape of frequency response. This norm characterizes the maximum amplifications that the system can produce on the input signals. In particular in the case of an SISO (single input, single output) function, the value of the maximum amplitude Gᵢ of the i-th mode of the frequency response may be approximated, under the assumption of weak dampings, by:

$${‖ {G}_{i} ‖}_{∞} = \frac{\vert {c}_{i} {b}_{i} \vert}{2 {ξ}_{i} {ω}_{i}^{2}} \qquad ( 7 )$$

Moreover, the Hankel singular values (HSV) associated with the state representation of relation (6) are the values of the equilibrated grammian. This grammian is a positive diagonal matrix defined by Γ=diag(σᵢ), which characterizes the degree of joint controllability and observability, of each component of the state vector. In the present case of nodal representation, each HSV therefore here characterizes the degree of controllability and of observability of the vibratory mode of the system in question. In the case of weak dampings, the HSVs are defined by:

$${σ}_{i} = \frac{\vert {c}_{i} {b}_{i} \vert}{4 {ξ}_{i} {ω}_{i}^{2}}$$

It therefore follows that ∥Gᵢ∥_{∞=}2σᵢ.

For the first k resonant modes, where k<p, to be dominant, they must guarantee significant HSVs, for good controllability/observability. The model reduced to the first k modes, Gᵣ, is defined according to the following relation:

$${G}_{r} ( jω ) = {\sum }_{i = 1}^{k} {G}_{i} ( jω )$$

This model Gᵣ reflects the behavior of the complete system G with a discrepancy, relating to the omitted HSVs, defined by the following relation:

$${‖ G - {G}_{r} ‖}_{∞} \leq 2 {\sum }_{i = k + 1}^{p} {σ}_{i}$$

To render the first k modes dominant and simultaneously improve the precision of the model truncated to these first k modes, the optimization criterion J₁, the evaluation function, may therefore be written:

$${J}_{1}^{k} = \frac{{\sum }_{i = 1}^{k} {σ}_{i}}{{\sum }_{i = k + 1}^{p} {σ}_{i}}$$

σᵢ representing the Hankel singular values (HSV) associated with the state representation of relation (6) for the particular natural mode No. i.

This criterion has an indicator, score, function so that the larger is J₁^{K} the more the system exhibits good controllability and observability simultaneously for the first k modes and poor controllability and observability simultaneously for the other modes. In practice, this criterion will favor systems for which only the first k modes are dominant.

FIGS. 5a and 5b illustrate the loci of the poles, represented by crosses x, and those of the zeros, represented by circles o, of the frequency response of a respectively undamped and slightly damped colocated system, in the complex plane where the abscissae represent the real response Re(s) and the ordinates represent the imaginary response Im(s).

A second criterion used by the method according to the invention, J₂, characterizes the colocation behavior of flexible systems. A property of these systems, which is advantageously utilized by the invention, is the alternation of the poles and zeros in the complex half-plane. Such systems are at phase minimum and the phase response oscillates continuously between 0° and 180° corresponding respectively to the zeros and to the poles of the response. Colocated systems are known for these beneficial properties, which make it possible to ensure stability of their closed-loop control.

According to the invention, an evaluation function may be used to estimate whether the behavior of a given structure may be considered to be close to a colocated system, and therefore to have criteria of simple stability. This evaluation function is the criterion J₂, defined for the first k modes by the following relation:

$${J}_{2}^{k} = \vert {\sum }_{i = 1}^{k} sign ( {c}_{i} {b}_{i} ) \vert$$

where sign(cᵢbᵢ)=+1 or −1 depending on whether the sign of the argument of the complex response is respectively positive or negative, sign(cᵢbᵢ) being equal to 0 if the argument is zero. The sum over the index i relates to all the modes contained in the frequency spectrum of the first k modes.
cᵢ and bᵢ respectively represent the influence of the sensors and actuators on the input/output frequency response of the system.

In the SISO case notably, maximization of the criterion J₂ makes it possible to favor structures which show an alternation of the poles and zeros. This criterion therefore favors structures whose first k static gains of Gᵢ are of the same sign. In practice, this amounts to favoring systems exhibiting an alternation of poles and of zeros for the first k modes.

FIG. 6 illustrates the mesh of the symmetric part of a micro-actuator together with the boundary conditions, with four blocks 61, 62, 63, 64 to be determined and nodes 65, 66, 67 admissible for disabling, these nodes being the three nodes at the bottom. An output node 68 representing the so-called effector node, forming the terminal member of the actuator. By way of example, the global optimization carried out by the method according to the invention is applied to design this micro-actuator, more particularly to design a piezoelectric monolithic structure, with integrated actuator, for micromanipulation tasks. The specification of the problem takes account here of four optimization criteria simultaneously:
two static mechanical criteria, the maximizations of the displacement δₓ and of the force F_{X} of the effector node 68 of the structure;
the two criteria J₁ and J₂ characterizing the transfer between the integrated actuation and the effector node 68.

In this example, we choose to take k=2, that is to say to consider only the first two resonance modes, for the determination of the criteria J₁ and J₂. In this precise case, the criterion J₂ can only take two discrete values. The maximum value is 2, case of colocation, or 0, case of non-location.

Finally, the optimal synthesis is carried out in this example for a symmetric mechanism made of a piezoelectric material.

FIG. 6 illustrates the specification of the problem. The fixed data are the dimensions of the symmetric part, the modal damping and the fixed electrical potential difference V for the active blocks. The modal damping is for example taken constant and equal to 1% for all the resonance modes.

The mesh of FIG. 6 is produced in a plane O, x, y. The symmetric part has dimensions L1×L2, L1 being for example equal to 15 mm and L2 to 9 mm, for a z-wise thickness of 200 μm. This part is formed of four blocks 61, 62, 63, 64 to be optimized, the blocks each having their own specific dimension a along the dimension L1 and their own specific dimension b along the dimension L2. The active blocks are those possessing electrodes which are powered, by the voltage V equal for example to 200 volts, so as to utilize the piezoelectric effect. The passive blocks are made of the same material but without electrodes. The size of the blocks can vary for a between a maximum value aₘₐₓ and a minimum value aₘᵢₙ in such a way that the ratio aₘₐₓ/aₘᵢₙ can vary between 1 and 2. Likewise, the dimension b can vary between a maximum value bₘₐₓ and a minimum value bₘᵢₙ in such a way that the ratio bₘₐₓ/bₘᵢₙ can vary between 1 and 2.

In the example of FIG. 6, the mechanical parameters to be optimized are for example the displacement along the x axis and the clamping force along the x axis of the output node 68. Stated otherwise, when the structure is voltage controlled, the output node 68 must produce:
the largest possible displacement δₓ along the x axis;
the largest possible clamping force Fₓ along the x axis.

The control may be an electrical voltage exerting a deformation of the piezoelectric beams.

FIGS. 7a, 7b, 7c and 7d illustrate four examples of solutions called A, B, C and D respectively, arising from the Pareto front of dimension four (since here four optimization criteria are considered) obtained on convergence of the optimization procedure, to analyze the contribution of the use of the criteria J₁ and J₂ according to the invention in the course of the optimization. The performance of the four structures is reported in the table hereinbelow where δₓ represents the displacement of the effector 68 along the x axis and Fₓ its clamping force along this same axis.

| | |
|---|---|
| Selected | Results of the criteria |

| solutions | δₓ | Fₓ | J₁ | J₂ |
|---|---|---|---|---|
| A | 15.55 μm | 1.26N | 2.24 | 0 |
| B | 11.74 μm | 1.26N | 21.00 | 0 |
| C | 12.34 μm | 0.63N | 0.28 | 2 |
| D | 10.69 μm | 0.84N | 5842.35 | 2 |

FIGS. 7a, 7b, 7c and 7d are the geometric representations of the four piezoelectric actuators. The structures of these actuators are composed of an assemblage of blocks, arising for example from the library of FIG. 1 and each formed of one or more segments 3 whose ends form nodes 70 at which the segments can be fixed to one another.

The solid lines 71 represent the active blocks and the dashed lines 72 represent the passive blocks. In the example of FIG. 7a, the two left blocks 61, 63 are passive, the right blocks 62, 64 are active, the middle node 66 being disabled. In the example of FIG. 7b, the blocks at the top left 61 and at the bottom right 64 are passive, the blocks at the top right 62 and at the bottom left are active, the left nodes 65, 66 being disabled. In the example of FIG. 7c, the bottom left block 63 is passive, the right blocks 62, 64 are active, the right nodes 66, 67 being disabled. In the example of FIG. 7d, the bottom left block 63 is passive, all the other blocks 61, 62, 64 are active, the left nodes 65, 66 being disabled.

Within the context of a conventional optimization, that is to say with just the two static mechanical criteria δₓ, F_{X}, only the solutions A and B would have been retained in a first step as they comply with the optimization hereinabove, namely the largest possible displacement δₓ along the x axis and the largest possible clamping force F. Solutions A and B do indeed maximize these two mechanical criteria. Solutions C and D would have been discarded and deleted from the Pareto front on account of their less good static mechanical performance. But it turns out that structure A possesses poor dynamic performance with a view to its subsequent control, as illustrated by FIG. 8 and confirmed by the criteria J₁ and J₂.

FIG. 8 presents by a Bode diagram the response of the displacement δₓ of the effector 68 following a harmonic excitation in voltage for the structure A of FIG. 7a. The amplitude of the response is represented by a first curve 81 as a function of frequency and the phase is represented by a second curve 82 as a function of frequency. The first curve departs from that of the ideal case expressed in FIG. 4 for the amplitude 81. The second curve illustrates the greatly non-phase-minimum feature. The phase curve 82 shows that the input-output transfer does not have the beneficial property of alternation of poles and zeros, which was illustrated in FIGS. 5a and 5b, expressed by continuous oscillations of the phase between 0° and −180°, in the chosen spectrum. Indeed a discontinuity 83 appears breaking the continuous succession of poles and zeros, corresponding to the succession of two antiresonances between the first two resonances 84, 85 and actually J₂ is equal to 0 in the above table. Moreover, the authority of control over these first two resonances is low in comparison to the other modes. Indeed the spikes 84, 85 which represent them are not maximized with respect to the other spikes 86 placed outside of the frequency band of interest, and the value of whose amplitude is not reduced, corresponding to an absence of drop in the gain, this being confirmed by the low value of J₁.

FIG. 9 presents again by a Bode diagram the frequency response of the displacement δₓ of the effector 68 under the same conditions but for the structure B of FIG. 7b, by an amplitude curve 91 and a phase curve 92. Remarks of the same kind as those regarding the structure A may be made. The authority of control over the first two resonance modes is correct as shown by the significant drop in the gain after the second resonance 93 on the amplitude curve 91, this being confirmed by a fairly good value of the criterion J₁ in the above table. However, one does not observe the feature of continuous alternation between the poles and the zeros in view of the phase curve 92 in the frequency domain of interest and J₂ actually equals 0.

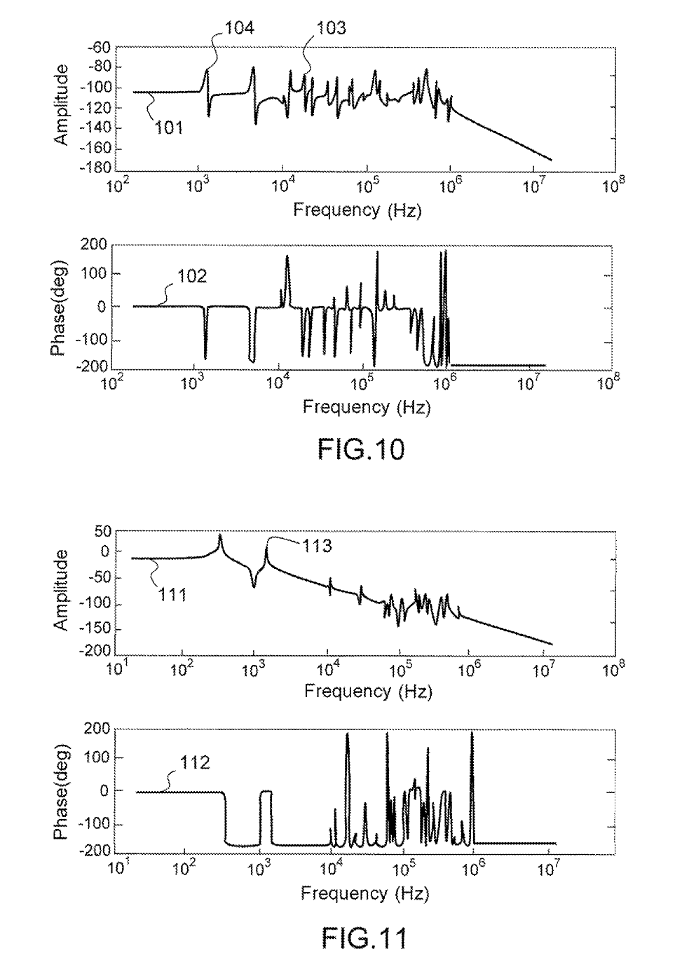

FIG. 10 illustrates the case of the structure C of FIG. 7c. In this case where the criterion J₂ is equal to 2, the frequency response exhibits a resonance/antiresonance alternation which does indeed vary continuously as far as the second resonance mode, as shown by the amplitude curve 101 of the Bode diagram. On the other hand, there exist resonance modes of higher frequency which are as dominant as certain modes of the frequency domain of interest. For example, the amplitude of the fourth resonance 103 is almost as significant as the amplitude of the first 104, this being confirmed by the very low value of the criterion J₁, so that these high-dynamic resonant modes may not reasonably be neglected in the synthesis of the reduced model, which would bring about an infeasible regulator synthesis and identification phase in view of the very significant amount of dynamics that would have to be considered in order to arrive at a precise model.

Finally, FIG. 11 illustrates the case of the structure D of FIG. 7d. It ultimately turns out that this structure can exhibit a beneficial compromise. The shape of its frequency response is indeed that expected, both in terms of amplitude, as illustrated by curve 111 of the Bode diagram, where there is a sharp decay after the second resonance 113, and as regards the continuous alternation of the resonances and antiresonances in the frequency domain of interest. This makes this structure a mechatronic system whose truncated model (limited to the first two resonances) will be precise, easy to identify and amenable to easy synthesis of its regulator in view of the criterion J1, and the stability of whose subsequent closed-loop control will be guaranteed in view of the criterion J2. The structure D appears to be that which exhibits the best compromise between mechanical performance, related to the criteria δₓ and Fₓ, and dynamic performance, with a view to control, related to the criteria J₁ and J₂.

The previous examples show that the criteria J₁ and J₂ make it possible for certain characteristics of the dynamic response of a system, influencing notably its subsequent control, to be taken into account right from the design step. More precisely, they make it possible to design flexible systems which exhibit frequency characteristics propitious to the implementation of conventional control laws which are simple and/or dedicated to flexible systems.

1. A method for producing a flexible mechatronic system, said method comprising:
a step of modeling the system by a finite element meshing;
a step of simulating the behavior of a terminal node of the model in open-loop response to a control signal;
a step of characterizing said response by at least one mechanical criterion and at least one numerical criterion J₁^{k} representative of the relative amplitude of the resonance spikes of said response as a function of frequency, these resonance spikes being chosen respectively upstream and downstream of a predetermined mode number;
the above steps being able to be repeated, these steps being followed by a step of selecting a design obtained as a function of the criteria defined in the characterization step, the system being produced on the basis of the selected design.

2. The method as claimed in claim 1, wherein the criterion J₁^{k} is defined by the following relation:
$${J}_{1}^{k} = \frac{{\sum }_{i = 1}^{k} {σ}_{i}}{{\sum }_{i = k + 1}^{p} {σ}_{i}}$$
where k is the number of first modes having to be dominant with respect to all the other modes of said frequency response and σᵢ, defined on the basis of the state representation which completely characterizes the input/output relation of the mechanism, is the i-th Hankel Singular Value of the flexible system.

3. The method as claimed in claim 1, wherein the characterization step comprises another numerical criterion J₂^{k} representative of the alternation of the resonances and antiresonances of the response in the frequency domain, in a chosen frequency band.

4. The method as claimed in claim 3, wherein the criterion J₂^{k} is defined by the following relation:
$${J}_{2}^{k} = \vert {\sum }_{i = 1}^{k} sign ( {c}_{i} {b}_{i} ) \vert$$
where k is the number of first resonance modes of said frequency response and cᵢ and bᵢ respectively represent the influence of the sensors and actuators on the input/output frequency response of the system.

5. The method as claimed in claim 1, wherein an embodiment is selected when the criterion J₁^{k} is greater than a value chosen by the user/the designer.

6. The method as claimed in claim 1, wherein an embodiment is selected when the criterion J₂^{k} is greater than a given value.

7. The method as claimed in claim 1, wherein the mesh is composed of a combination of elementary blocks to be determined, each permitted block being formed of a predefined assemblage of segments representing elementary beams, said mesh comprising at least one active block controllable by means of a control signal.

8. The method as claimed in claim 1, wherein the mesh being composed of a combination of elementary blocks to be determined, each permitted block being formed of a predefined assemblage of segments representing elementary beams, said mesh comprises at least one node controllable by means of a control signal.

9. The method as claimed in claim 7, wherein the blocks arise from a library of predefined blocks.

10. The method as claimed in claim 7, wherein a control of an active block is exerted by a deformation signal for at least one of its beams.

11. The method as claimed in claim 1, wherein a static mechanical criterion is the displacement δₓ of the terminal node.

12. The method as claimed in claim 1, wherein the terminal node being an effector, a mechanical criterion is the value of the force that it applies to the exterior medium Fₓ.

13. The method as claimed in claim 1, wherein the control signal is an electrical voltage or current signal.

14. The method as claimed in claim 1, wherein the system is a piezoelectric actuator, all the beams constituting an active block being controlled by an electrical voltage signal.
